(19) United States
(12) Patent Application Publication
(10) Pub. No.: US 2004/0115526 A1
(43) Pub. Date: Jun. 17, 2004

(54) Laminant container with fitment

(76) Inventors: Thongkhanh P Lewandowski, Michigan, MI (US); Ronald R Francis, Hudsonville, MI (US); Lisa marie Massaro, Midland, MI (US); William Edward Orabone JR., Salxmoor, MI (US); Jenifer l Tetu, Midland, MI (US)

Correspondence Address: Kenneth I Kohn, Kohn & Associates, Suite 410, 30500 Northwestern Hwy, Farmington Hills, MI, 48334, US

(21) Appl. No.: 09/869,178

(22) PCT Filed: Jan. 26, 2001
(86) PCT No.: PCT/US01/02780

(51) Int. Cl. H01M 2/02; H01M 2/08; B65D 25/40

(52) U.S. Cl. 429/176; 429/185; 53/133.2

(57) ABSTRACT

According to the present invention, there is provided a container for use in storing an energy storage cell, the container including a package material of at least two layers physically attached to one another and extending material extending outside the container whereby the extending material transfers electrical and thermal energy into outside of the container through a fitment. Also provided by the present invention is a fitment for creating a leak proof seal in a container for containing an energy storage cell made up of a heat sealable material. A method of making a container by forming a package material of at least two layers, extending a metal material from the inside of the package material through a fitment, thereby preventing leakage is also provided.

### BACKGROUND OF THE INVENTION

1. Field of the Invention

The present invention relates to a laminate container which is leak proof, water and air tight for storing energy storage cells. More specifically, the present invention relates to a flexible sealed container which allows for materials to be extended from the interior to the exterior of the container while maintaining a leak proof water and air tight enclosure.

2. Description of Related Art

There are many instances in industry where it is desired to allow for a material to extend from the internal portion of a flexible package to the external of the package while maintaining a leak proof, water and/or air tight seal. However, an effective adhesive seal has never been achieved.

One such application is in the field of dual graphite energy storage systems and also in the field of electrochemical devices. There are known methods of providing protection to batteries from oxidation, such as for example, encasing the battery in a metal container. Those skilled in the art know that terminals are formed by feedthroughs which pass through the container. When a metal or other electrically conductive container is used, a glass-to-metal feedthrough is often employed. A major consideration in the production of batteries of all types is energy density. Commercial demand by the electronic industry requires high energy density sources which are difficult to achieve with many of the prior art encasements, such as a metal container. Examples of electrochemical cells sealed in flexible polymer containers are described in the prior art. U.S. Pat. No. 4,092,464 (A. N. Dey et al.), U.S. Pat. No. 4,997,732 (Austin et al.), U.S. Pat. No. 6,080,508 (Dasgupta et al.), and U.S. Pat. No. 5,326,652 (R. C. Lake) describe electrochemical cells enclosed in a polymer laminate bag where the terminals themselves, or the laminate, carry a coating of heat-sealable material which permits the formation of a thermally formed seal between the polymer laminate bag and the terminals. U.S. Pat. No. 5,591,540 (Louie et al.) describes a three layered laminate package material where a metal tab extends through the package. These patents disclose the need for adhesion between the surface of the metallic terminal and a heat sealable material but provide no detailed instruction on how this is achieved. U.S. Pat. No. 4,507,857 (Epstein et al.) describes a feedthrough arrangement where a pair of electrically conductive members are located on respective sides of an interjacent through-hole formed in the laminate material, and the pair of electrically conductive members are bonded together, by heating (welding), through the hole to form the feedthrough. It is known that polymer laminates can be durably bonded together by applying heat and pressure, however, the bond between the metal surface of the tabs or terminals and the polymer films may not be sufficiently air-tight, and oxygen and/or moisture may enter at the metal-polymer interface into the battery package unless strong adherence between the metal and the plastic or polymer laminate can be implemented.

The prior art describes various laminate materials that may be used for dual graphite energy storage systems and also in the field of electrochemical devices. A defect that may arise in conventionally packaged rechargeable batteries, wherein the metal foil located between the protective layers of the laminate comes in contact with one or both of the metallic terminals or tabs resulting in a electrical short within the battery. Such a defect may be caused by the heat sealing process, diminishing the thickness of the polymer layer, or the edges of the metal terminal or feedthrough may cut through to the enclosed metallic foil, or by similar events. It would therefore be useful to develop a fitment which overcomes these problems.

Batteries, with metallic electrodes, often have a limited life-cycle due to the degradation of the metallic electrodes. For example, lithium is known to be highly reactive in humid air. Therefore, batteries are manufactured in an environment of low humidity and often in a vacuum or protective atmosphere. In use, lithium negative electrodes (anodes) can be attacked and/or passivated by electrolytes and moist air. This results in formation of lithium powder with a very high surface area. This is undesirable because lithium powder, and especially high surface area lithium, reacts violently with moisture and air. Composite anode alternatives have been suggested to overcome such problems, but they are prone to a large loss of capacity as compared to metallic lithium.

Containers for foods, beverages, and drugs often include agents to prevent oxygen attack of the contents therein. U.S. Pat. Nos. 4,840,280 and 4,615,926 disclose the typical packaging technology. It is typical to have headspace above the contents of the container which contains an oxygen scavenger. The scavenger is held in the headspace by a permeable film between the contents and the scavenger. Such a construction is not suitable for protecting lithium cells because communication between the scavenger and the cell contents is unacceptable. In another typical container, a multiple film container has peelable layers which permits easy access to the contents. Layers of film which easily separate from one another should never be used for protecting lithium cells because the contents are highly volatile and should never be exposed while in use.

It would therefore be useful to develop a housing for electrochemical cell (battery) components and devices for preventing exposure and degradation of such components, particularly lithium, over an extended period of battery use.

### SUMMARY OF THE INVENTION

According to the present invention, there is provided a container for maintaining a leak free environment, the container including a package material of at least two layers physically attached to one another, a fitment for maintaining the leak free environment and an extending material disposed within the fitment by compression. Also provided by the present invention is a fitment for creating a leak proof seal, the fitment being made up of a heat sealable material. A method of making a container for containing an energy storage cell by forming a package material of at least two layers and extending a metal material from the inside of the package material through a fitment, thereby preventing leakage.

### DESCRIPTION OF THE DRAWINGS

Other advantages of the present invention will be readily appreciated as the same becomes better understood by reference to the following detailed description when considered in connection with the accompanying drawings wherein:

FIG. 1 is a front schematic showing a football shaped fitment in relation to the laminant container containing feedthrough holes;

FIG. 1(b) is a schematic showing a top view of the fitment, showing the fitment with tab materials extending from the internal portion of the fitment to the external portion of the fitment;

FIG. 1(c) is a top schematic view showing a completed laminated film container incorporating a fitment and tab extension from the internal portion of the fitment to the external portion of the fitment;

FIG. 2 is a schematic showing a top view of the frame shaped fitment, the design including tab materials extending from the internal portion of the fitment to the external portion of the fitment; and

FIG. 3 is a schematic representation of the multi-layer laminant material and the adherence to a fitment.

### DETAILED DESCRIPTION OF THE INVENTION

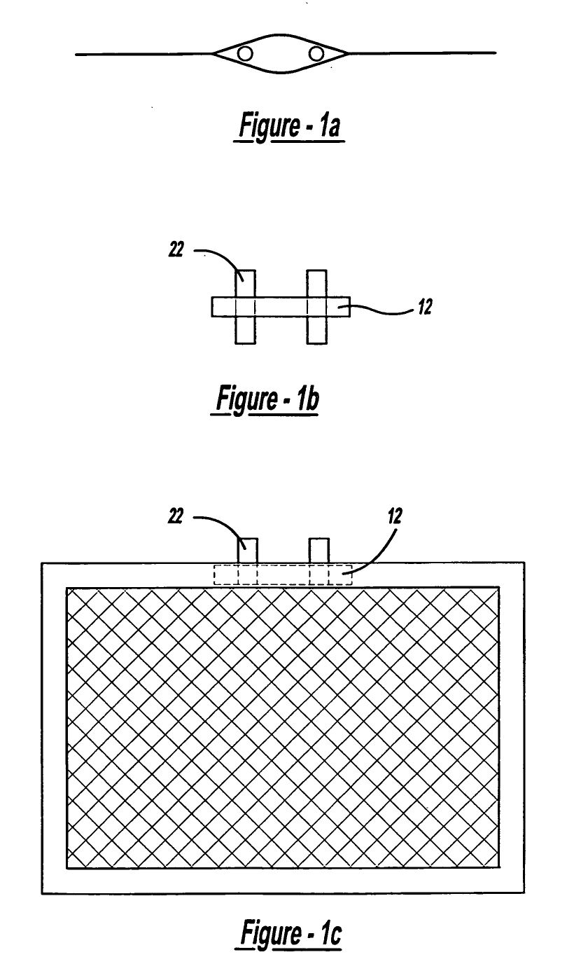

Generally, a container made in accordance with the present invention is generally shown at 10 in FIG. 1. The container 10 includes a package material 14 of at least two layers which are fixably attached to one another, a fitment 12 for maintaining the leak free environment and an extending material 28 which extends outside the container 10 whereby the extending material 28 is disposed within the fitment 12.

By “extending material 28” as used herein, the term is meant to include, but is not limited to, electrodes, leads, hoses, and other similar materials known to those of skill in the art to be found in a battery, i.e. terminals, pressure relief valves, sensors.

By “package material 14” as used herein, the term is meant to include, but is not limited to layers which together formulate the container 10 for containing a battery. These layers can include polymeric materials, strength and tear resistant layers 18, sealants 26, heat resistant materials 16 and other materials known to those of skill in the art to be useful in a battery container 10.

By “fitment 12” as used herein, the term is intended to include, but is not limited to a piece of material which is used to allow for a material to extend from the internal portion of the container to the external of the container while maintaining a leak proof, water and/or air tight seal by compression. The fitment 12 can be made of a polymer or other heat sealable material as are known to those of skill in the art In the preferred embodiment, the fitment 12 is in the shape of a football, elliptical, as seen in FIG. 1. Alternatively, the fitment 12 can be of any shape which can be used to seal the container 10. The fitments feedthrough holes provide a compression fitting between the package and the extending material.

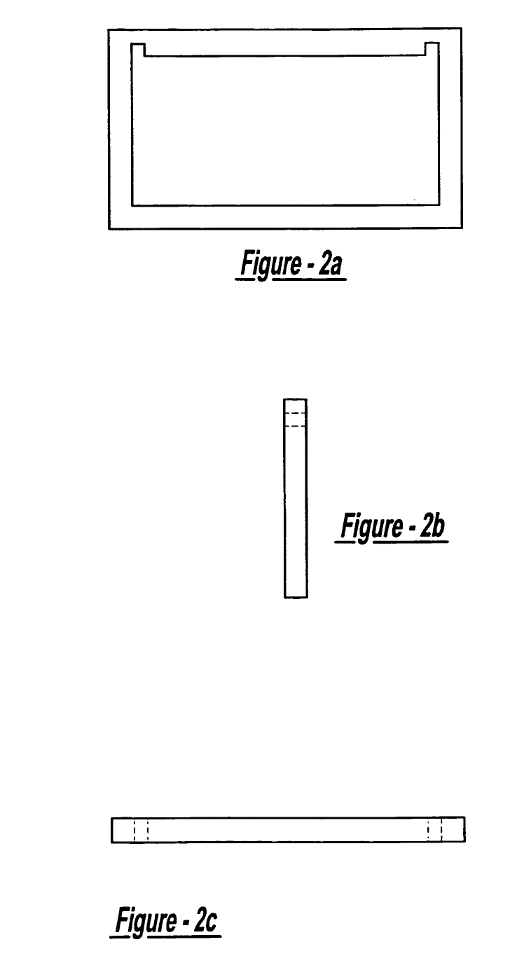

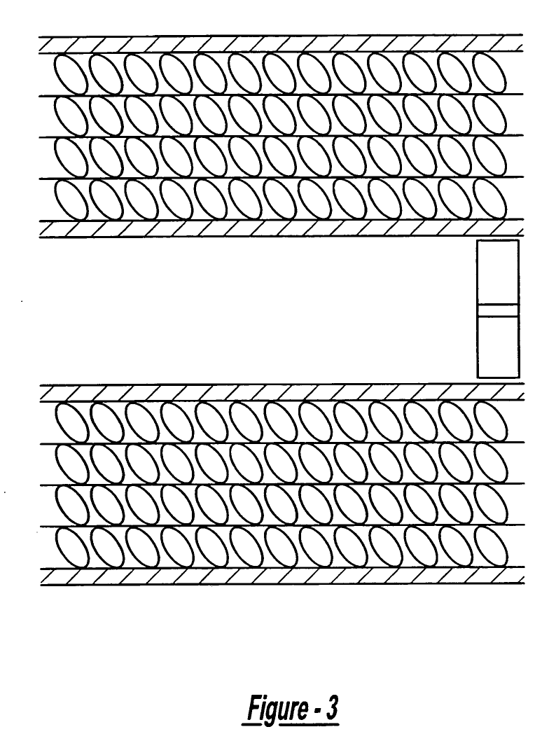

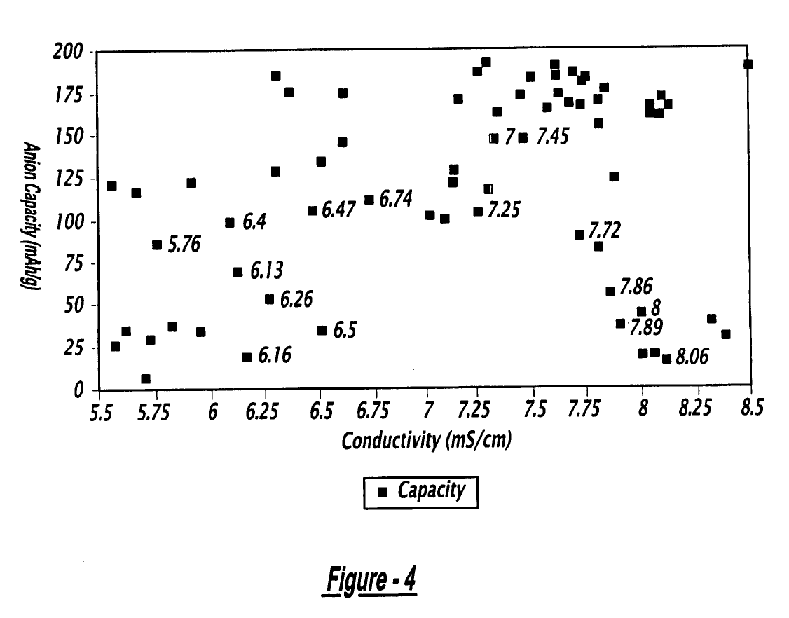

In another embodiment of the present invention, the fitment 12 is in the form of a frame. This is best depicted in FIG. 2. In this embodiment, the fitment 12 includes tab materials 13 which extend from the internal portion of the fitment 12 to the external portion of the fitment 12.

A package material 14 of the present invention includes a laminate 30 which is provided for use as a protective covering for inhibiting penetration of oxygen and/or oxygen and water therethrough, or other undesirable materials. The laminate 30 functions to protect the contents of the container 10. For example, the laminate 30 can protect components of an electrochemical cell such as a lithium battery. The laminate 30 includes at least two layers, one of which has a polymeric layer for heat sealing layers of the laminate 30 to one another, and the other is an oxygen and/or moisture barrier.

In the preferred embodiment, the laminate 30 insulates as well as inhibits transport and transmission of electricity. Further, the laminate 30 inhibits transport and transmission of oxygen and water through the laminate 30. The laminate 30 includes two or more layers having, when combined, the characteristics of flexibility, electrical insulation, adhesiveness, and stability in the presence of water. A heat sealable polymeric layer can constitute one of the two layers. An oxygen/water barrier is included in the laminate 30 as described above.

The container 10 is in the form of a bag or pouch having an opening adaptable to be heat sealed and a peripheral layer with inner and outer surfaces, layers between such surfaces where at least one of the layers comprises the polymeric material which forms a heat seal to itself to seal such opening and wherein the polymeric heat sealing material constitutes the inner layer. In such an arrangement, the inner heat sealing layer is made of an electrically insulating polymeric material, a metal foil layer on the outside of the insulating sealant layer, and an outer layer of a durable polymeric material having a tensile strength of at least 9,000 psi. The metal foil layer is sandwiched between the durable outer layer and the heat sealable electrically insulating inner layer. An oxygen and/or water scavenging compound may be disposed between any of the layers or incorporated in any of the layers. Desirably, the heat sealable electrically insulating layer is an ionomer, EVA, EAA, or a polyolefin and preferably is EVA or polyethylene. The exterior layer is desirably a polymeric amide or polyester and preferably either nylon or polyethylene terephthalate. It is preferred that the metal foil is aluminum.

In a preferred embodiment the laminate 30 which forms the container 10 is constituted by seven layers arranged from interior layer (the layer facing the contents of the container 10) to exterior layer (the surface facing the environment and away from the contents). The layers include heat sealable polymeric layer, olefin based adhesive polymer, polyamide or polyester or a bonded polyolefin based polymer, olefin based adhesive, metal foil layer, olefin based adhesive polymer, and an exterior polyamide or polyester based polymer layer.

A suitable multi-layer packaging laminate 30 having four layers is constituted by an interior heat sealable layer 16, exterior layer of polyester or polyamide resin, a central structural layer, preferably made of a metal foil, with an adhesive bonding polyolefin or EAA or EVA layer disposed between the barrier layer and the interior layer.

Oxygen scavenging agents 22 can be selected from a group of metal oxides, carbides, hydroxides, carbonates, sulfites, carbonyls, silicides, and mixtures thereof. One particularly suitable oxygen scavenging agent 22 comprises fine particles of copper oxide supported on particles of aluminum. Where the oxygen scavenging agent 22 is incorporated into one of the polymeric layers, it can be so combined by mixing together pellets of polymeric material and particles of a metal compound having a reducing property, such as copper oxide, and then extruding such mixture to form a sheet thereof.

In the case where the oxygen scavenging agent 22 is incorporated between layers, it is preferred that such agent 22 be incorporated closest to the foil and between the polyethylene and nylon layers in an exemplary seven layer configuration. Where the oxygen scavenging agent 22 is to be incorporated into and extruded with one of the polymeric layers, it is preferred that it be coextruded with polyethylene polymer. It is preferred that the scavenger 22 should not absorb or come in contact with the solvent associated with the battery.

Many oxygen scavenging agents 22 can be used in the invention. For example, oxygen scavengers customarily used in the field of food and drug preservatives can be used as the oxygen scavenger in the present invention. In general, an oxygen scavenger having a reducing property and being substantially insoluble in water is preferably used. For example, an oxygen scavenger comprising as the main component at least one member selected from the group consisting of metal powders having a reducing property, such as reducing iron powder, reducing zinc powder and reducing tin powder, low-valence metal oxides such as a ferrous oxide and triiron tetoxide, and reducing metal compounds such as iron carbide, iron silicide, iron carbonyl and iron hydroxide. The oxygen scavenger can be used in combination with an assistant such as a hydroxide, carbonate, sulfite, thiosulfate, tertiaryphosphate, secondary phosphate, organic acid salt or halide of an alkali metal or alkaline earth metal, or active carbon, active alumina or activated clay according to need.

Furthermore, a high-molecular-weight compound having a polyhydric phenol in the skeleton, such as a polyhydric phenol-containing a phenovaidehyde resin, can be used as the oxygen scavenger. In general, it is preferred that the oxygen scavenger should have an average particle size smaller than 10 microns, desirably smaller than 4×10⁻⁶ meter (micron), especially smaller than 1×10⁻⁶ meter (micron).

Some oxygen absorber materials are triggered by the presence of even a small amount of humidity in the air. Examples are sulfide salts such as potassium sulfite which becomes highly oxygen attractive (oxophilic) in the wet state. The oxygen scavenger potassium sulfite (K₂ SO₃) can be mixed with a carrier material. Another gas absorption composition consists of fine particles of copper oxide supported on particles or spheres or high surface area alumina. In the reduced state, copper oxide is a highly effective oxygen scavenger capable of eliminating up to 99% of oxygen present in gases which can penetrate the laminate 30. One such copper based oxygen absorber is available from Engelhard of Elyria, Ohio under the designation CU-0226 in 14 to 20 mesh spheres which needs to be ground to about 10 microns and which have typical properties as listed below in Table I:

TABLE I
Typical Properties

| | |
|---|---|
| Surface Area, m.sup 2/gm | |
| Total Pore Volume, cm.sup. 3/gm | 0.50 |
| Packed ABD, g/cc | 0.81 |
| Copper oxide, wt % at 250. degree. C. | |
| Nickel oxide, wt % 250. degree. C. | 0.4 |
| Color-grayish green to black | |

In one embodiment, pellets of a copolymer used in one of the layers of the laminate 30 is mixed with an oxygen scavenger such as the CU-0226 in a batch wise, high speed, stirring vane-type mixture. The mixture can then be pelletized by a pelletizer comprising an extruder having a screw. A multi-layer laminate 30 comprising the pelletized mixture and other layers can be produced by a multi-layer sheet forming machine comprising extruders for the various layers which are then formed in a suitable dye, cooled on a cooling roller, and advanced by means of a take-up device. In another embodiment, the oxygen scavenger, in its particle form, can be placed between the extruded layers before they are laminated together in the dye. Thus, the films of the invention are preferably made by coextrusion process, though other processes are acceptable so long as the resulting film is functionally integral for the life of the container 10 and prevents intrusion of oxygen into the compartment occupied by the battery.

A water absorbing agent can also be used in combination with the oxygen scavenger. Some oxygen absorbing agents are activated by water or their effectiveness is increased in the presence of water. A delinquent inorganic salt or organic compound can be used in the invention as well as water absorbing resins. Examples of such compounds and resins include sodium, calcium, zinc and ammonium chlorides, sulfates and nitrates; and organics such as starch, cellulose, sugars, and organics having a carboxyl group and a cross-linked structure. Other examples are silica, alumina, silica-alumina and gels thereof. The combination of a metal oxide and alumina, as described above with copper oxide supported on alumina, is particularly suitable. In the case of potassium sulfite, it can be replaced by an interacting mixture of potassium acetate and sodium sulfite where moisture is taken up by such interacting mixture to form the potassium sulfite which is an oxygen absorber. Many metal oxides such as iron oxides react in the presence of moisture with gaseous oxygen to form higher oxidation state metal oxides and halides. A typical example is Fe(OH)₂+¼O₂+½H₂ O═Fe(OH)₃. Thus, ferrous (Fe+2) form of iron reacts in the presence of moisture with oxygen to produce the ferric (Fe+3) form of iron. Still other examples of oxygen scavengers are sodium dithionite, metal halides and combination of compounds such as an iron containing sulfur combined with a metal halide The various oxygen and oxygen and water scavenging products are more particularly described in the following U.S. patents, which are each incorporated herein by reference: U.S. Pat. Nos. 3,117,259, 4,702,966, 5,077,111, 5,153,038, 4,840,280, 5,143,763 and 4,856,650.

Accordingly, the present invention provides an improved container 10 which maintains a leak proof environment throughout the life of the container 10. In one embodiment of the present invention, the container 10 is used for an electrochemical battery, or a dual graphite battery assembly, which maintains integrity of the battery over a prolonged life cycle as compared to presently used battery assemblies. The container 10 of the present invention can also include an agent 22 to take up oxygen or oxygen and water preventing attack of the reactive components of the container 10.

The above discussion provides a factual basis for the use of the container 10 of the present invention. The methods used with and the utility of the present invention can be shown by accompanying figures. The container 10 of the present invention can be used in association with a variety of products and is not limited in its uses based on the above examples.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

1. Container for maintaining a leak free environment, said container comprising:
a package material of at least two layers fixedly attached to each other;
a fitment for maintaining the leak free environment; and
an extending material disposed within said fitment and held in place by compression.

2. The container according to claim 1, wherein said packaging material comprises:
a heat resistant layer;
a strength and tear resistant layer fixedly attached to said heat resistant layer;
a moisture and oxygen barrier layer fixedly attached to said strength and tear resistant layer, and
a sealant layer fixedly attached to said moisture barrier layer.

3. The container according to claim 2, wherein said container includes a second strength and tear resistant layer fixedly attached between said moisture barrier and said sealant layer.

4. The container according to claim 2, wherein said container includes a be layer fixedly attached between said moisture barrier and said sealant layer, thereby increasing the attachment between said moisture barrier and said sealant layer.

5. The container according to claim 1, wherein said extending material is selected from the group consisting essentially of metals, metal alloys, and polymeric and glass materials.

6. The container according to claim 2, wherein said fitment is made from a material selected from the group consisting essentially of polypropylene, polyethylene, combinations thereof, and other heat sealable material.

7. The container according to claim 6, wherein said fitment includes feedthrough holes extending therethrough.

8. The container according to claim 2, wherein said layers are heat fused using a method selected from the group consisting essentially of heat fusing with a PE laminate and fusing with a solvent based adhesive placed between said layers.

9. The container according to claim 2, wherein a moisture and/or oxygen scavenging compound is in said sealant layer or is positioned between said sealant layer and barrier layer.

10. The container according to claim 9, wherein said moisture scavenging compound is selected from the group consisting essentially of a molecular sieve powder, silica, and other moisture scavenging compounds.

11. A fitment for creating a leak proof seal in a container, said fitment comprising a heat sealable material.

12. The fitment according to claim 11, wherein said heat sealable material is selected from the group consisting essentially of polypropylene, polyethylene, combinations thereof, and other heat soluble materials.

13. The fitment according to claim 11, said fitment including feedthrough holes.

14. The fitment according to claim 11, wherein said fitment is elliptical in shape.

15. The fitment according to claim 11, wherein said fitment is a frame.

16. A method of making a container for containing an energy storage cell by:
forming a package material of at least two layers;
extending a metal material from the inside of the package material through a fitment; and
thereby preventing leakage.

17. The method according to claim 16, wherein said forming step includes heat fusing the package material with a PE laminate.

18. The method according to claim 16, wherein said forming step includes fusing the package material with a solvent based adhesive placed between layers of said package material.
